(19) United States
(12) Patent Application Publication
(10) Pub. No.: US 2004/0077747 A1
(43) Pub. Date: Apr. 22, 2004

(54) Antimicrobial superfinish and method of making

(76) Inventor: Stephen A. Payne, Charlotte, NC (US)

Correspondence Address: MICROBAN PRODUCTS COMPANY, 1115 VANSTORY DRIVE, SUITE 125, HUNTERSVILLE, NC, 28078, US

(21) Appl. No.: 10/467,356

(22) PCT Filed: Feb. 5, 2002
(86) PCT No.: PCT/US02/03485

(51) Int. Cl. C08K 3/00

(52) U.S. Cl. 523/122

(57) ABSTRACT

The present invention concerns a durable textile coating having antimicrobial properties such that the colorfastness, hand, and absorbency of the textile is not significantly changed from a textile having no such coating thereon. In particular, the coating, when applied to cotton or cotton blend towels, for example, drastically reduce or eliminate mold, mildew, fungus and bacteria on the cotton towels. This effectively controls stain and odor on the towels. More particularly, the microemulsion coating comprises polyurethane, plasticizer, and an antimicrobial agent. The microemulsion coating (antimicrobial composition) comprises from about 90 to about 95% by weight polyurethane or co-polyurethane; from about 1 to about 5 weight % plasticizer; and from about 1 to 5 weight % antimicrobial agent, with the total being 100 percent. A coating composition for textiles is then made with this microemulsion composition by taking 3 to 7 parts of the antimicrobial composition, and mixing with 93 to 97 parts water (for a total of 100 parts). This aqueous based composition is then applied to a textile and dried. The anti-microbial coated textile is effective for at least 50 launderings in accordance with AATCC Test Method 147-1993.

### BACKGROUND OF THE INVENTION

1. Field of the Invention

The present invention concerns a durable textile coating having antimicrobial properties such that the colorfastness, hand, and absorbency of the textile is not significantly changed from a textile having no such coating thereon. In particular, the coating, when applied to cotton or cotton blend towels, for example, drastically reduce or eliminate mold, mildew, fungus and bacteria on the cotton towels. More particularly, the microemulsion coating comprises polyurethane, a plasticizer, and an antimicrobial agent.

2. Prior Art

There are known antimicrobial textile finishes comprising silicones and other type resins but, when antimicrobial agents are mixed with these known textile finishes, the resultant product is not durable to fifty home launderings (an industry standard) and it must be continuously mixed before application as the antimicrobial agent quickly settles.

Accordingly, it is an aim and object of the present invention to produce a antimicrobial effective composition, effective to at least 50 home launderings which is stable (does not settle quickly) has good colorfastness, good hand, and good absorbency when compared with a control having no antimicrobial composition. These aims and objects produce advantages in that the present invention is far superior as a textile finish to those known in the art based on silicon, and other types of resins (not polyurethane resins).

Accordingly, the need in the art to produce the characteristics advantages, aims, and objects above is meet by the present invention.

### SUMMARY OF THE INVENTION

The present comprises a coating composition which includes three materials, namely: 1) a polyurethane (or copolyurethane), 2) a plasticizer, and 3) an antimicrobial agent. This composition is generally created and then 3 to 7 parts are then mixed with water for a total of 100 parts, and coated on a textile article. Then textile article is cotton or cotton blends such as polycotton. It is preferred that the polyurethane or copolyurethane be self-crosslinking and is preferably based on a copolymer of ethylene oxide and propylene oxide, reacted with a diisocyanate. Suitable plasticizers are those that are compatible with polyurethane and preferably comprise triacetin. Suitable anti-microbial agents are those that are effective after 50 laundries according to AATCC Test 147-1993, and preferably is triclosan.

A method of making the antimicrobial composition, coating it on a textile article, and drying the article is also disclosed.

In the broadest sense, the present application comprises a composition coated on a textile comprising polyurethane, plasticizer, and an antimicrobial agent.

In the broadest sense, the present invention also concerns a method of producing a coated textile article comprising producing a textile article, coating said article, and drying said article wherein the dried coating comprises polyurethane resin, plasticizer, and an antimicrobial agent.

In the broadest sense, the present invention additionally comprises an aqueous coated composition comprising from about 3 to about 7 parts of antimicrobial composition and from 93 to 97 parts water such that the total aqueous composition comprises 100 parts, wherein said anti-microbial composition comprises polyurethane, plasticizer, and an antimicrobial agent.

### DESCRIPTION OF THE INVENTION

The present invention employs a self-crosslinking polyurethane or polyurethane copolymer that does not crosslink or otherwise react with the natural or synthetic fibers (i.e. cotton or polycotton blends) of the textile. Because the polyurethane is self-crosslinking, preferably no catalyst is needed nor desired. The polyurethane is durable to the typical industry standard of fifty home launderings, it reduces pilling of the textile (the pulling apart and balling of individual fiber filaments), and it improves abrasion resistance. The plasticizer is generally a liquid having a low vapor pressure at room temperature and is used to: 1) modify flow properties of synthetic resins, 2) reduce evaporation rate, and 3) input flexibility and toughness to the polyurethane or polyurethane copolymer. The antimicrobial agent is also compatible with the polyurethane or polyurethane copolymer. Therefore no separation of the components occurs.

A particularly preferred self-crosslinking polyurethane resin is sold by Bayer Co. under the trademark BAYPRET™. Under the BAYPRET products, BAYPRET USV is particularly preferred. This product appears to be polyurethane made from a block ethylene oxide/polypropylene oxide copolymer reacted with a diisocyanate such as hexamethylene diisocyanate with acetic acid salt and an antioxidant. Other suitable polyurethane resins can comprise a one or two component polyurethane resin coatings sold under the trademark IMPRANIL or IMPRAPERM which are solvent free and permeable to water vapor. These products are both aliphatic and aromatic urethane resins and are also sold by Bayer Co. Other suitable polyurethanes are sold by Merquinst of Spain which has a full line of thermoplastic polyurethanes.

Any plasticizer compatible with polyurethane or polyurethane copolymer, and compatible with the antimicrobial agent are suitable for the present invention. A preferred plasticizer is triacetin or glycerol triacetate, also known as 1,2,3-propanetriol triacetate. It is commercially available, for example, under the trade name Triacetin by Eastman Chemical Company. Other suitable plasticizers are propylene glycol, triacetate. It is commercially available, for example, under the trade name Triacetin by Eastman Chemical Company. Other suitable plasticizers are propylene glycol, propylene glycol benzoate, DINP—Diisononyl Phthalate and DIDP—Diisodecyl Phthalate.

Suitable antimicrobial agents suitable with the present invention may be 2,4,4-trichloro-2-hydroxydiphenyl ether (also known as triclosan); 2-phenylphenol; diiodomethyl-4-tolylsulfone; zinc-2-mercaptopyridine-N-oxide; and N-alkyl-N, N-dimethyl-N-benzylammonium chloride. Of these antimicrobial agents, triclosan is preferred.

When the polyurethane or copolyurethane, plasticizer and antimicrobial agent are blended together, it tends to have a light blue or bluish-gray color. This mixture (the antimicrobial composition) is then blended with water. About 93-97 parts of water are thoroughly blended with about 3-7 parts of the light blue or blue-gray color mixture, and then the aqueous blend is applied to the textile article, and dried. Drying crosslinks the coating with itself, but the coating does not interact with the textile article.

More specifically, the light blue or blue-gray mixture comprises from about 90-95% by wt. polyurethane or polyurethane copolymer resin (Baypret USV, for example); from about 1-5% by wt. plasticizer; and from 1-5% by wt. antimicrobial agent, with the total being 100%. More preferably, the plasticizer and antimicrobial agent are typically blended together in a 50-50 wt. percent blend and 5-10% by wt. is added to the polyurethane or copolyurethane resin (totaling 100% by weight) with the mixer running at a medium speed during the addition. Most preferably, 94 parts of the resin is blended with 6 parts of the 50-50 blend (plasticizer and antimicrobial agent). Next, the light blue or blue-gray mixture (3-7 parts) is mixed with water to 100 parts total, producing the coating formulation. At the end of mixing, the aqueous antimicrobial resin finish is permitted to settle, to allow the bubbles of air to separate from the coating formulation.

Next, the coating formulation is applied to the textile product by any conventionally known method such as spraying, dipping, rollbrush application, etc. The (gained) between 20 and 100% wt. over the dry wt. of the textile article, depending on whether the article is made from synthetic (polycotton) or natural fibers, as well the construction of the textile (non-woven, woven or knitted). The amount of coating formulation is applied such that it equates to 3-5 grams of dried coating per 100 grams of textile article. The coating must be cured at about 130° C. for at least about 1 minute so that all of the water is evaporated and bonding occurs without the use of a catalyst.

The amount of antimicrobial agent in the dried residue on the examples is about 0.09-0.15% by wt. Various active concentrations of the antimicrobial agent within the formulation were compared at the 1%, 2%, 3%, and 4% by wt. level. A more durable finish can be produced when the concentration of the antimicrobial agent is lessened or reduced within the formulation. Accordingly, one skilled in the art would use sufficient amount to accomplish the antimicrobial effect but for economic reason and durability reasons would use no more than what is necessary. Generally this is between 2 and 4% by wt. of the antimicrobial agent in the wet coating on the textile.

### Testing Procedure

AATCC Test Method 147-1993 is the industry test for antimicrobial effectiveness with the staphylococcus aureus (gram negative) being ATCC 6538 and the klebsiella pneumoniae (gram positive) being ATCC 4352 where the textile sample size was 25 millimeters by 50 millimeters and the nutrient broth was incubated at 37° C.+/−2° C. for eighteen to twenty four hours.

The colorfastness to laundering was conducted according to AATCC Test Method 61-1989 using Test #2A at 120° F. using 50 steel balls for 45 minutes of wash time with no chlorine added and 0.15% by wt. detergent of the total liquor volume of 150 milliliters for each 2 by 6 inch test sample. One wash according to AATCC-Test Method 61-1989 with Test #2A is equivalent to 5 home or commercial launderings. The results of these tests show that the textile article, when compared to an untreated textile article had good colorfastness.

### EXAMPLE 1

100% cotton loop towels were submerged in an aqueous antimicrobial bath comprising about 77 parts water, polyurethane resin (21 parts BAYPRET), plasticizer (0.70 parts Triacetin) and an antimicrobial agent (0.70 parts Triclosan), and the excess liquid was removed by squeeze rolls. The textile articles were dried at 130° C. in a conventional oven. The towels had approximately 22-23% pickup of the antimicrobial coating formulation that was mixed in the application bath at 227 g/liter. Thus 0.15% of the antimicrobial agent was incorporated into the towel by wet on wet pad application. The antimicrobial concentration was present on the dried textile article in Example 1 at about 5 weight %.

The antimicrobial effectiveness was determined on unwashed textile articles, textile articles after 50 washes and the textile articles after 100 washes. The test (AATCC Test Method 147-1993) determines if the antimicrobial agent effectively inhibits the growth of staphylococcus aureus (ATCC 6538 Gram-negative bacteria) and klebsiella pneumoniae (ATCC 4352 Gram-positive bacteria). The results are set forth in Table 1.

TABLE 1

| | S. aureus | K. pneumoniae |
|---|---|---|
| Unwashed | 20 mm | 15 mm |
| 50 washes | 17 mm | 10 mm |
| 100 washes | 14 mm | 10 mm |

Although the antimicrobial agent is incorporated into a polymer (polyurethane) it has antimicrobial efficacy, especially against stain and odor causing bacteria. It was observed that the colorfastness, fiber retention, and softness of hand of an antimicrobial treated textile article are superior to that of an uncoated textile article. The coated textile has minimum loss of absorbency compared to an uncoated textile article. Lastly, the coating composition is transparent and does not yellow.

### EXAMPLE 2

100% cotton loop towels like those set forth in Example 1 were tested for colorfastness using the exact same finish composition as set forth in Example 1. The colorfastness was conducted on burgundy towels, a color which is difficult to achieve good results. The colorfastness was conducted under AATCC Test Method 61-1989 as set forth above.

Additionally, the burgundy towels were tested for antimicrobial effectiveness using the same procedures in Example 1, except the antimicrobial concentration was present on the dried textile article in Example 1 at about 3 weight %. In this Example, the amount of antimicrobial material was cut in half, i.e., 1.5 weight %. The results were noted after 0 launderings, 25 launderings, 50 launderings, 75 launderings, and 100 launderings. In addition to the good colorfastness, it was observed that these towels had good hand and good absorbency when compared with the control (0 launderings). The results of the antimicrobial effectiveness are set forth in Table 2.

TABLE 2

| | | Results (Zone Size) |
|---|---|---|
| Sample Identification | S. aureus | K. pneumoniae |
| 0 launderings | 31 mm | 31 mm |
| 25 launderings | 16 mm | 8 mm |
| 50 launderings | 9 mm | 7 mm |
| 75 launderings | 7 mm | NZ/I |
| 100 launderings | 6 mm | NZ/I |

Interpretation of Results
NZ = No Zone of inhibition surrounding the sample
NI = No Inhibition of Growth Under the Sample
I = Inhibition of Growth Under the Sample (If Observable)
mm = Zone of Inhibition Reported in Millimeters

### EXAMPLE 3

In this example a 50/50 polycotton blend textile was tested for both colorfastness and antimicrobial effectiveness employing the same test set forth above with respect to Example 1. In this Example the amount of antimicrobial material tested ranged from 0 (the control) to 0.06% and to 0.09% by weight, based on the weight of the textile. The amount of launderings for the control was 25 and 100 launderings. For the 0.06% by weight antimicrobial agent the test for colorfastness and antimicrobial effectiveness were after 25 launderings, and 100 launderings. For the 0.09% by weight antimicrobial agent present in the finish, 75 launderings and 100 launderings were the plateau for testing. In this Example all of the colorfastness results were good. The antimicrobial test results are set forth in Table 3.

TABLE 3

| | | Results (Zone Size) |
|---|---|---|
| Sample Identification | S. aureus | K. pneumoniae |
| Control; 25 launderings | 4 mm | NZ/I |
| Control; 100 launderings | NZ/I | NZ/I |
| 0.06%; 25 launderings | 7 mm | 5 mm |
| 0.06%; 100 launderings | 5 mm | 5 mm |
| 0.09%; 75 launderings | 5 mm | 7 mm |
| 0.09%; 100 launderings | 9 mm | 8 mm |

Interpretation of Results
NZ = No Zone of inhibition surrounding the sample
NI = No Inhibition of Growth Under the Sample
I = Inhibition of Growth Under the Sample (If Observable)
mm = Zone of Inhibition Reported in Millimeters

Thus it is apparent that there has been provided, in accordance with the invention a durable finish composition and a method that fully satisfies the objects, aims and advantages set forth above. While the invention has been described in conjunction with the specific embodiments thereof, it is evident that many alternatives, modifications, and variations will be apparent to those skilled in the art in light of the foregoing description. Accordingly, it is intended to embrace all such alternatives, modifications, and variations as fall within the spirit and the broad scope of the present invention.

What is claimed is:

1. A composition coated on textiles comprising: polyurethane, plasticizer, and an antimicrobial agent.

2. The composition of claim 1, wherein said polyurethane comprises from about 90 to 95 weight % of said composition.

3. The composition of claim 2, wherein said plasticizer comprises from about 1 to 5 weight % of said composition.

4. The composition of claim 3, wherein said antimicrobial agent comprises from about 1 to 5 weight % of said composition.

5. An aqueous based coating composition comprising from about 3 to about 7 parts of said composition of claim 1, and from about 93 to about 97 parts water, based on 100 total parts.

6. The composition of claim 2, wherein said polyurethane is self-crosslinking.

7. The composition of claim 6, wherein said polyurethane is made from a block ethylene oxide/polypropylene oxide copolymer reacted with diisocyanate.

8. The composition of claim 3, wherein said plasticizer is selected from the class of triacetin, propylene glycol, or propylene glycol benzoate, DINP—Diisononyl Phthalate, and DIDP—Diisodecyl Phthalate.

9. The composition of claim 4, wherein said antimicrobial agent is selected from the class of triclosan; 2-phenylphenol; diiodomethyl-4-tolylsulfone; zinc-2-mercaptopyridine-N-oxide; and N-alkyl-N, N-dimethyl-N-benzylammonium chloride, propiconazole, and Sodium Omadine (pyridine).

10. A coated textile product comprising: a textile article and a composition coated thereon as claimed in claim 1, wherein said textile has from about 3 to about 5% by weight of said composition thereon.

11. The coated textile product of claim 10, wherein said coating comprises from about 90-95 weight % polyurethane, from about 1-5 weight % plasticizer, and from about 1-5 weight % antimicrobial agent.

12. The coated textile product of claim 11, wherein said product remains antimicrobial effect after 50 launderings according to AATCC Test Method 147-1993.

13. The coated textile product of claim 12, wherein said antimicrobial effectiveness is against stain and odor causing bacteria.

14. The coated textile product of claim 10, wherein said textile article is cotton or polycotton blend.

15. A method of producing an antimicrobial textile article product comprising:
producing a cotton or polycotton textile article;
coating said textile article with an effective amount of an antimicrobial composition; and
drying said textile to produce the product;
wherein said dried coating comprises from about 90-95 weight % polyurethane, from about 1-5 weight % plasticizer, and from about 1-5 weight % antimicrobial agent.

16. The method of claim 15, wherein said product remains antimicrobial effect after 50 launderings according to AATCC Test Method 147-1993.

17. The method of claim 15, wherein said polyurethane is self-crosslinking.

18. The method of claim 17, wherein said polyurethane is made from a block ethylene oxide/polypropylene oxide copolymer reacted with diisocyanate.

19. The method of claim 15, wherein said plasticizer is selected from the class of triacetin, propylene glycol, or propylene glycol benzoate, DINP—Diisononyl Phthalate and DIDP—Diisodecyl Phthalate.

20. The method of claim 15, wherein said antimicrobial agent is selected from the class of triclosan; 2-phenylphenol; diiodomethyl-4-tolylsulfone; zinc-2-mercaptopyridine-N-oxide; and N-alkyl-N, N-dimethyl-N-benzylammonium chloride propiconazole, and Sodium Omadine (pyridine).
